(19) United States
(12) Patent Application Publication
(10) Pub. No.: US 2019/0066554 A1
(43) Pub. Date: Feb. 28, 2019

(54) AUTOMATIC OPTIC INSPECTION DEVICE AND INSPECTION SYSTEM FOR DISPLAY PANEL

(71) Applicants: BOE TECHNOLOGY GROUP CO., LTD., Beijing (CN); FUZHOU BOE OPTOELECTRONICS TECHNOLOGY GROUP CO., LTD., Fujian (CN)

(72) Inventors: Yong WANG, Beijing (CN); Hongyan GUO, Beijing (CN); Yoseop CHEONG, Beijing (CN); Yang YU, Beijing (CN); Guiping ZHONG, Beijing (CN); Huailiang WU, Beijing (CN); Zongtian XIE, Beijing (CN); Cundui TANG, Beijing (CN); Zengyang JIANG, Beijing (CN); Baota LI, Beijing (CN)

(73) Assignees: BOE TECHNOLOGY GROUP CO., LTD., Beijing (CN); FUZHOU BOE OPTOELECTRONICS TECHNOLOGY GROUP CO., LTD., Fujian (CN)

(21) Appl. No.: 16/026,512

(22) Filed: Jul. 3, 2018

(30) Foreign Application Priority Data
Aug. 31, 2017 (CN) 201710774919.X

(51) Int. Cl. G09G 3/00; G06F 11/22; G03B 17/56; H04N 5/225

(52) U.S. Cl. CPC G09G 3/006; H04N 5/2252; G03B 17/561; G06F 11/2221

(57) ABSTRACT

An automatic optic inspection device and an inspection system for a display panel. The automatic optic inspection device includes: a housing including at least a top wall and a side wall, the side wall including a viewing port; a slide rail fixed on the housing near the top wall; and a camera slidably disposed below the slide rail. An optical axis of the camera passes through the viewing port. During the inspection, the camera is moved on the slide rails so that the camera is close to the stage of the lighting inspection machine and can perform automatic optic inspection of the display panel. When the automatic optic inspection device fails to inspect due to a fault, the camera can be moved along the slide rail so that the camera is moved away from the stage and manual inspection can take place while the inspection device is fixed.

### RELATED APPLICATIONS

The present application claims the benefit of Chinese Patent Application No. 201710774919.X, filed on Aug. 31, 2017, the entire disclosure of which is incorporated herein by reference.

### TECHNICAL FIELD

The present disclosure relates to the field of display devices, in particular to an automatic optic inspection device and an inspection system for a display panel.

### BACKGROUND

The display panel is an important part of the display. At present, common display panels include the liquid crystal display panel and the organic electroluminescent display panel. No matter what kind of display panel, it needs to be tested after the manufacture is completed.

At present, there are mainly two methods for inspection of the display panel, one is a conventional manual inspection, and the other is an AOI (automatic optic inspection). For the manual inspection method, the display panel is lighted by a lighting inspection machine, and then inspection personnel observe the lighted display panel to determine whether the display panel has any kind of defects. For the AOI, the display panel is lighted by a lighting inspection machine, and then image information of the lighted display panel is acquired by a camera of the AOI device, and the acquired image information is analyzed by the inspection system of the AOI device to determine whether there are any defects in the display panel.

### SUMMARY

The embodiments of the present disclosure provide an automatic optic inspection device and an inspection system for a display panel.

According to an embodiment of the present disclosure, an automatic optic inspection device is provided. The automatic optic inspection device includes: a housing including at least a top wall and a side wall, the side wall being provided with a viewing port; a slide rail fixed on the housing and near the top wall; and a camera slidably disposed on the slide rail and located below the slide rail. An optical axis of the camera passes through the viewing port.

In some embodiments, an extending direction of the slide rail is parallel to the optical axis of the camera.

In some embodiments, a driving device is disposed on the slide rail, and the driving device is configured to drive the camera to slide along the slide rail.

In some embodiments, the housing includes a support frame on which the sidewall is disposed.

In some embodiments, the housing further includes a movable door.

In some embodiments, the automatic optic inspection device further includes: an inspection and analysis device disposed inside the housing; wherein the inspection and analysis device is configured to perform inspection according to image information acquired by the camera.

In some embodiments, the inspection and analysis device is located at a side of the housing away from the viewing port.

In some embodiments, a side door is provided at a location on the housing corresponding to the inspection and analysis device.

In some embodiments, the housing further includes a light shielding plate surrounding the viewing port.

In some embodiments, the housing further includes a display device electrically connected to the camera.

In some embodiments, the housing further includes an operating panel.

In some embodiments, the housing further includes a plurality of rollers disposed at the bottom of the housing.

According to another embodiment of the present disclosure, an inspection system for a display panel is provided. The inspection system includes a lighting inspection machine and an automatic optic inspection device as described in the above embodiments.

In some embodiments, the optical axis of the camera is perpendicular to the loading surface of the stage of the lighting inspection machine.

In some embodiments, the extending direction of the slide rail is parallel to the optical axis of the camera.

In some embodiments, a driving device is disposed on the slide rail, and the driving device is configured to drive the camera to slide along the slide rail.

In some embodiments, the housing includes a support frame on which the sidewall is disposed.

In some embodiments, the housing further includes a movable door.

In some embodiments, the inspection system further includes: an inspection and analysis device disposed inside the housing; wherein the inspection and analysis device is configured to perform inspection according to image information acquired by the camera.

In some embodiments, the inspection and analysis device is located at a side of the housing away from the viewing port.

### BRIEF DESCRIPTION OF THE DRAWINGS

In order to more clearly illustrate the technical solutions in embodiments of the invention or in the prior art, the appended drawings needed to be used in the description of the embodiments or the prior art will be introduced briefly in the following. Obviously, the drawings in the following description are only some embodiments of the invention, and for those of ordinary skills in the art, other drawings may be obtained according to these drawings under the premise of not paying out creative work.

FIG. 1 is a structural schematic diagram of an automatic optic inspection device provided by an embodiment of the present disclosure;

FIG. 2 is a structural schematic diagram of a slide rail provided by an embodiment of the present disclosure;

FIG. 3 is a partially enlarged schematic view of an automatic optic inspection device provided by an embodiment of the present disclosure;

FIG. 4 is a structural schematic diagram of another automatic optic inspection device provided by an embodiment of the present disclosure;

FIG. 5 is a structural schematic diagram of a support leg provided by an embodiment of the present disclosure; and

FIG. 6 is a structural schematic diagram of an inspection system for a display panel provided by an embodiment of the present disclosure.

### DETAILED DESCRIPTION OF THE DISCLOSURE

To make the objectives, technical solutions, and advantages of the present disclosure more clear, the embodiments of the present disclosure will be further described in detail below with reference to the accompanying drawings.

It is noticed that the AOI device is usually arranged together with the lighting inspection machine. Since the AOI device is close to the lighting inspection machine, when the AOI device cannot perform inspection (for example, the AOI device is closed down to perform maintenance or fails), the lighting inspection machine arranged together with the AOI device will also stop working, causing the lighting inspection machine to be idle, resulting in low inspection efficiency.

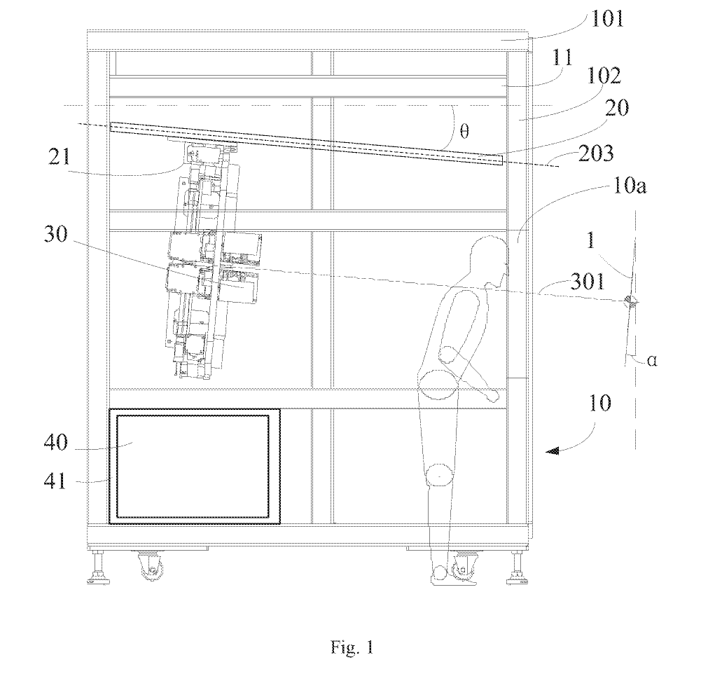

FIG. 1 is a structural schematic diagram of an automatic optic inspection device provided by an embodiment of the present disclosure. As shown in FIG. 1, the automatic optic inspection device includes: a housing 10 including at least a top wall 101 and a side wall 102, the side wall 102 being provided with a viewing port 10a; a slide rail 20 fixed on the housing and near the top wall; and a camera 30 slidably disposed on the slide rail 20 and located below the slide rail 20. An optical axis 301 of the camera 30 passes through the viewing port 10a.

In embodiments of the present disclosure, the camera of the automatic optic inspection device is disposed on the slide rail. During the inspection, the display panel to be inspected is placed on the loading surface of the stage of the lighting inspection machine, and the camera is moved on the slide rails so that the camera approaches the stage of the lighting inspection machine and the camera directly faces the display panel, thereby performing automatic optic inspection. When the automatic optic inspection device fails to inspect due to a fault, the camera can be moved along the slide rail so that the camera is moved away from the stage. Since the camera is located below the slide rail, after the camera is moved to a position far from the stage of the lighting inspection machine, a large space is in the front of the lighting inspection machine, which can facilitate the entry of the personnel for manual inspection. The idleness of the lighting inspection machine is thus avoided and the inspection efficiency is improved.

In certain exemplary embodiments, as shown in FIG. 1, the extending direction 203 of the slide rail 20 may be parallel to the optical axis 301 of the camera 30. In this way, the moving direction of the camera 30 is parallel to the optical axis 301 of the camera 30. After the camera 30 moves a short distance along the slide rail 20, a large space between the camera 30 and the display panel 1 can be created. Moreover, the camera 30 can be aligned with the display panel to be inspected whether it is moving or not, and therefore it is not necessary to realign the camera 30 and the display panel 1 after each movement of the camera 30, thereby further improving inspection efficiency.

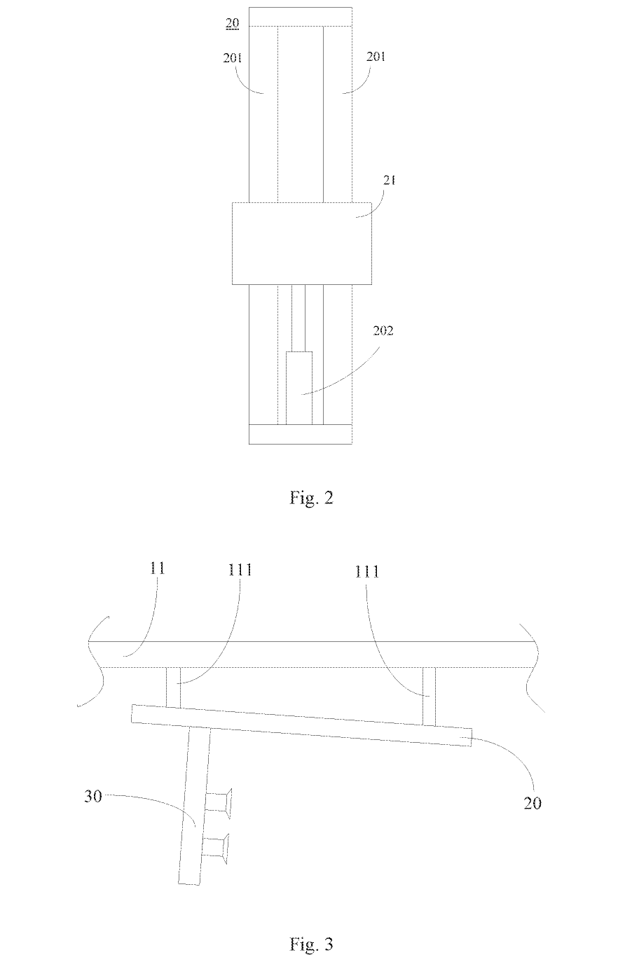

In certain exemplary embodiments, as shown in FIG. 2, the slide rail 20 may be provided with a driving device 202 configured to drive the camera 30 to slide along the slide rail 20. By providing the driving device, the camera 30 can be easily moved and the distance between the camera 30 and the stage of the lighting inspection machine can be adjusted.

Exemplarily, the slide rail 20 can be provided with a mount 21, the camera 30 can be disposed on the mount 21, and the driving device adjust the position of the camera 30 by driving the mount 21.

FIG. 2 is a structural schematic diagram of a slide rail provided by an embodiment of the present disclosure. As shown in FIG. 2, the slide rail 20 may include two slide rods 201 arranged in parallel and spaced apart, and the mount 21 is slidably mounted on the slide rods 201 (for example, the mount 21may be provided with two through holes, and two slide rods 201 are respectively inserted in the through holes). The mount 21 can be connected with the driving device 202. The driving device 202 can drive the mount 21 to move along the slide rod 201 so as to drive the camera 30.

It should be noted that the structure of the slide rail shown in FIG. 2 is only an example. In other embodiments, the slide rail may also adopt other structures.

The driving device 202 in the embodiment of the present disclosure may include a telescopic cylinder and a gas source. The central axis of the telescopic cylinder can be arranged parallel to the slide rail 20. One end of the telescopic cylinder can be fixedly connected with the mount 21, and the other end of the telescopic cylinder can be fixedly connected to the slide rail 20. The telescopic cylinder is connected with the gas source so that the telescopic cylinder can be extended and shortened driven by the gas source, thereby moving the mount 21 along the slide rail 20. The driving device may also include a hydraulic cylinder and a hydraulic pressure source. The hydraulic cylinder is driven by the hydraulic source and moves the mount 21.

It should be noted that the structure of the driving device provided in the embodiment of the present disclosure is only an example, and the structure of the driving device can be various. In other embodiments, the driving device may also be other structures that can drive the mount 21 to move along the slide rail 20.

In some embodiments, as shown in FIG. 1, the housing 10 may include a support frame 11 on which the side wall 102 is disposed. The support frame 11 can carry the entire automatic optic inspection device. For example, the support frame 11 may be a frame structure formed by connecting multiple support beams, and multiple support beams can be connected by welding or bolting.

As shown in FIG. 1, the support frame 11 may have a cuboid shape. In other embodiments, the support frame 11 may also have other geometric shapes, such as a cylindrical shape or the like.

The support frame 11 should have sufficient strength to support the weight of the entire automatic optic inspection device. For example, the support beam may be a steel structure. In addition, the support frame 11 can also be connected by angle steel, and the angle steels can be connected by welding.

The slide rail 20 can be fixedly mounted on the support frame 11 so that the slide rail 20 is stable enough to ensure the smoothness of the camera 30 during its movement.

FIG. 3 is a partially enlarged schematic view of an automatic optic inspection device provided by an embodiment of the present disclosure. As shown in FIG. 3, two hanging rods 111 may be disposed on the slide rail 20 with an interval. One end of the hanging rod 111 is connected to the slide rail 20, and the other end of the hanging rod 111 is fixedly connected to the support frame 11. Thus, the slide rail 20 is fixedly mounted on the support frame 11.

It should be noted that the installation method shown in FIG. 3 is only an example, and is not used to limit the disclosure. In actual installation, the slide rail 20 may be fixedly mounted on the support frame 11 by using other installation methods.

In certain exemplary embodiments, as shown in FIG. 1, the slide rail 20 is disposed inclined to the horizontal direction, and the end of the slide rail 20 close to the viewing port 10a is lower than the end away from the viewing port 10a. When performing the inspection of the display panel 1, the automatic optic inspection device is usually used in conjunction with a lighting inspection machine. The display panel 1 to be inspected is placed on a loading surface of a stage of the lighting inspection machine, and the display panel 1 is inclined (with respect to the vertical plane). Disposing the slide rail 20 in this way can make the optical axis of the camera 30 always perpendicular to the display panel 1 to be inspected, which facilitates inspection of the display panel 1. For example, when a display panel 1 with a small area is inspected, the camera 30 needs to be close to the display panel 1. When a display panel 1 with a large area is inspected, the camera 30 needs to be far from the display panel 1. Since the optical axis 301 of the camera 30 is always perpendicular to the display surface of the display panel 1 to be inspected during the movement, when inspecting the display panel 1 of different sizes, the display panel 1 can always be in the middle of the picture taken by the camera 30.

In some embodiments, as shown in FIG. 1, the inclination angle θ (an angle of inclination with respect to the horizontal plane) of the slide rail 20 and the inclination angle α (an angle of inclination with respect to the vertical plane) of the loading surface of the stage of the lighting inspection machine used in conjunction with the automatic optic inspection device should be equal, so that the optical axis 301 of the camera 30 is always perpendicular to the display panel 1 to be inspected.

In certain exemplary embodiments, as shown in FIG. 1, the automatic optic inspection device further includes an inspection and analysis device 40 disposed inside the housing 10. The inspection and analysis device 40 is configured to perform inspection according to the image information acquired by the camera 30. The inspection and analysis device 40 is disposed within the housing 10, and the camera 30 is electrically connected with the inspection and analysis device 40. The image information acquired by the camera 30 is analyzed by the inspection and analysis device 40, thereby inspecting defects of the display panel.

In certain exemplary embodiments, as shown in FIG. 1, the inspection and analysis device 40 is located at a side of the housing 10 away from the viewing port 10a, so that it is convenient for the inspection personnel to enter the housing 10 for manual inspection.

In certain exemplary embodiments, the inspection and analysis device 40 includes a cabinet 41 to facilitate the setting of the inspection and analysis device 40.

As shown in FIG. 1, the cabinet 41 may be located below the end of the slide rail 20 away from the viewing port 10a. In this way, when manual inspection is required, the camera 30 can be moved directly above the cabinet 41, and the space inside the housing 10 occupied by the cabinet 41 and the camera 30 can be reduced without occupying the space of the inspection personnel, which facilitates the entry of the inspection personnel into the housing 10 for manual inspection.

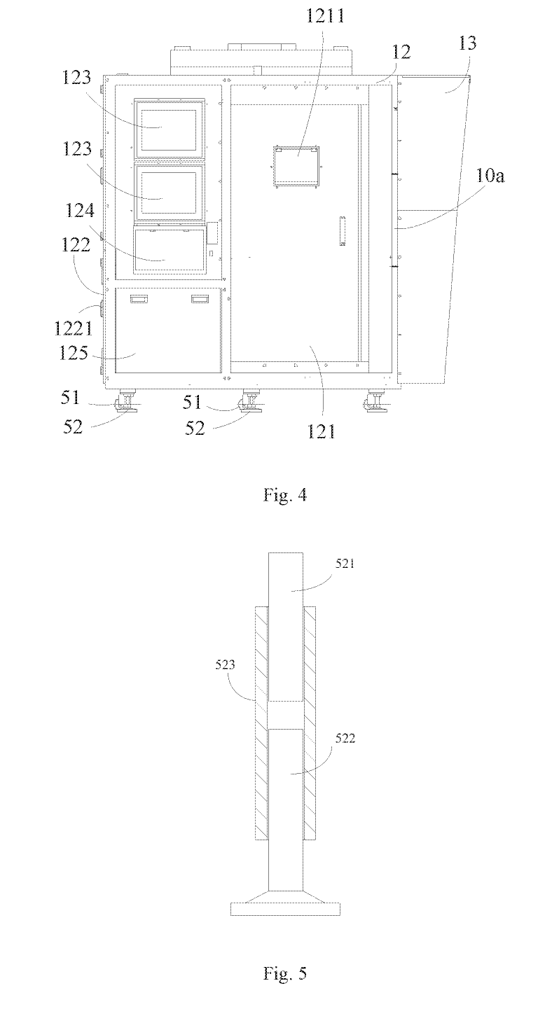

FIG. 4 is a structural schematic diagram of another automatic optic inspection device provided by an embodiment of the present disclosure. As shown in FIG. 4, the housing 10 may further include a hoarding plate 12 disposed on the support frame 11. The hoarding plate 12 encloses the slide rail 20, the camera 30, and the inspection and analysis device 40, so that the internal structure can be protected from impurities (e.g. dust). The side wall 102 can be formed by, for example, a hoarding plate 12. Moreover, the hoarding plate 12 made of a non-transparent material can also shield light, so that the interior of the automatic optic inspection device is in a dark environment, which can help to improve the quality of the picture captured by the camera 30 and make the inspection result more accurate. During the inspection of the display panel, the camera 30 captures a picture displayed on the display panel, and judges whether the display panel is defective through the picture displayed by the display panel. If dust enters the picture taken by the camera 30, black spots may appear on the picture displayed by the display panel, and the display panel may be erroneously considered to be defective.

In certain exemplary embodiments, as shown in FIG. 4, the housing 10 further includes a light shielding plate 13 surrounding the viewing port 10a. By providing the light shielding plate 13, when the automatic optic inspection device is used in conjunction with the lighting inspection machine, the light shielding plate 13 can be covered on the stage of the lighting inspection machine, so as to prevent the light in the environment from irradiating onto the display panel to be inspected. During the inspection, if light outside the automatic optic inspection device is irradiated on the display panel, it will cause reflection and affect the picture taken by the camera 30, thereby affecting the inspection of the display panel.

In certain exemplary embodiments, the hoarding plate 12 may be made of a light -proof material such as metal or plastic.

In some embodiments, as shown in FIG. 4, a movable door 121 may further be provided on the housing 10. By providing the movable door 121 on the housing 10, it facilitates the entry and exit of the inspection personnel.

Furthermore, a window 1211 may further be provided on the movable door 121 so that the worker can view the interior of the hoarding plate 12. The window 1211 may be sealed with a transparent material (e.g. plastic, glass, etc.) to prevent dust from entering.

Furthermore, a side door 122 may be provided at a location on the housing 10 corresponding to the inspection and analysis device 40. By providing the side door 122, the inspection and analysis device 40 can be conveniently placed inside the housing 10, and the inspection and analysis device 40 can also be conveniently maintained when it fails, without affecting the manual inspection.

As shown in FIG. 4, the side door 122 is disposed on the housing 10 opposite to the viewing port 10a. In this way, when maintenance is required, the maintenance personnel and the inspection personnel who enter the automatic optic inspection device to perform manual inspection can work at the same time without interferencing with each other, which helps to improve the inspection efficiency.

Exemplarily, the side door 122 may be connected to the housing 10 through a hinge 1221 to facilitate the opening of the side door 122.

Referring to FIG. 1, a cabinet 41 is located directly below the end of the slide rail 20 away from the viewing port 10a so that the camera 30 can be slid to a position directly above the cabinet 41. When the camera 30 fails, the maintenance personnel can also perform maintenance on the camera 30 through the side door 122.

As shown in FIG. 4, the housing 10 further includes a display device 123, and the display device 123 is electrically connected with the camera 30. By providing the display device 123 on the outer wall of the housing 10, the image information acquired by the camera 30 can be displayed by the display device 123, which is convenient for the personnel to view.

In addition, an operating panel 124 may further be provided on the outer wall of the housing 10 to facilitate the personnel to operate the device for inspection.

As shown in FIG. 4, the display device 123 and the operating panel 124 can be disposed on the same side of the housing 10, which can facilitate the personnel to view the image information and perform the device operation at the same time.

Exemplarily, the movable door 121, the display device 123, and the operating panel 124 may all be disposed on the same surface of the housing 10. The movable door 121 is close to the viewing port 10a, and the display device 123 and the operating panel 124 are located at a side of the movable door 121 away from the viewing port 10a. In the vertical direction, the operating panel 124 may be located directly below the display device 123. In this way, the operating panel 124 is at a lower position, and the display device 123 is at a higher position, which facilitates the operation and viewing of the personnel.

In addition, a wiring door 125 may further be provided on the housing 10. The camera 30, the display device 123, the operating panel 124, and the inspection and analysis device 40 are connected by various wirings. The wiring door 125 is provided and the wiring door 125 can be opened to facilitate connection of various wirings.

In certain exemplary embodiments, the bottom of the housing 10 may further be provided with a plurality of rollers 51 to facilitate the movement of the automatic optic inspection device.

In addition, the bottom of the housing 10 may further be provided with a plurality of support legs 52 of adjustable length. After the automatic optic inspection device is moved to a target position, the rollers 51 can be departed from the ground by adjusting the length of the support legs 52. The weight of the automatic optic inspection device is commonly supported by the plurality of support legs 52 to prevent the automatic optic inspection device from moving.

FIG. 5 is a structural schematic diagram of a support leg provided by an embodiment of the present disclosure. As shown in FIG. 5, the support leg 52 may include a first strut 521, a second strut 522, and a threaded sleeve 523. The first strut 521 and the second strut 522 are both provided with external threads, and the rotation directions of the external threads are opposite to each other. One end of the threaded sleeve 523 is threadedly connected with the first strut 521, and the other end of the threaded sleeve 523 is threadably connected with the second strut 522. Because the rotation direction of the thread on the first strut 521 is opposite to the rotation direction of the thread on the second strut 522, the first strut 521 and the second strut 522 can be simultaneously extended outwardly of the screw sleeve 523 or simultaneously retracted into the threaded sleeve 523 by rotating the threaded sleeve 523, thereby achieving the adjustment of the length of the support legs 52.

It should be noted that the structure of the support leg 52 shown in FIG. 5 is only an example. In other embodiments of the present disclosure, other forms of the adjustable length support leg 52 may also be provided.

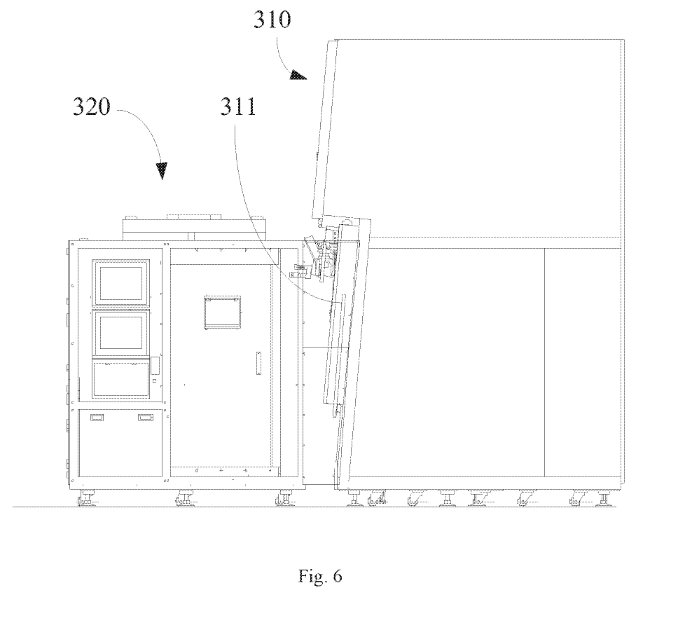

FIG. 6 is a structural schematic diagram of an inspection system for a display panel provided by an embodiment of the present disclosure. As shown in FIG. 6, the inspection system includes a lighting inspection machine 310 and an automatic optic inspection device 320 shown in FIG. 1 or FIG. 4.

In certain exemplary embodiments, the moving direction of the camera may be perpendicular to the loading surface 311 of the stage of the lighting inspection machine 310. Since the moving direction of the camera is perpendicular to the loading surface of the stage of the lighting inspection machine 310 (see FIG. 1), the camera can always directly face the loading surface of the stage during the movement of the camera. When inspecting a display panel with a small area, the distance between the camera and the stage can be reduced. When inspecting a display panel with a large area, the distance between the camera and the stage can be increased.

In some embodiments, as shown in FIG. 1, the extending direction 203 of the slide rail 20 may be parallel to the optical axis 301 of the camera 30. In this way, the moving direction of the camera 30 is parallel to the optical axis 301 of the camera 30. After the camera 30 moves a short distance along the slide rail 20, a large space between the camera 30 and the display panel 1 can be created. Moreover, the camera 30 can be aligned with the display panel to be inspected regardless of whether the camera 30 is moving or not, and therefore it is not necessary to realign the camera 30 and the display panel 1 after each movement of the camera 30, thereby further improving inspection efficiency.

In some embodiments, as shown in FIG. 2, the slide rail 20 may be provided with a driving device 202 configured to drive the camera 30 to slide along the slide rail 20. By providing the driving device, the camera 30 can be easily moved and the distance between the camera 30 and the stage of the lighting inspection machine can be adjusted.

In some embodiments, as shown in FIG. 1, the housing 10 includes a support frame 11 on which the side wall 102 is disposed. The support frame 11 can carry the entire automatic optic inspection device. For example, the support frame 11 may be a frame structure formed by connecting multiple support beams, and multiple support beams can be connected by welding or bolting.

In some embodiments, as shown in FIG. 4, the housing 10 further includes a movable door 121. By providing the movable door 121 on the housing 10, it facilitates the entry and exit of the inspection personnel.

In some embodiments, as shown in FIG. 1, the automatic optic inspection device further includes an inspection and analysis device 40 disposed inside the housing 10. The inspection and analysis device 40 is configured to perform inspection according to the image information acquired by the camera 30. The inspection and analysis device 40 is disposed within the housing 10, and the camera 30 is electrically connected with the inspection and analysis device 40. The image information acquired by the camera 30 is analyzed by the inspection and analysis device 40, thereby inspecting defects of the display panel.

In some embodiments, as shown in FIG. 1,the inspection and analysis device 40 is located at a side of the housing 10 away from the viewing port 10a, so that it is convenient for the inspection personnel to enter the housing 10 for manual inspection.

In the embodiments of the present disclosure, the camera of the automatic optic inspection device is disposed on the slide rail. During the inspection, the display panel to be inspected is placed on the loading surface of the stage of the lighting inspection machine, and the camera is moved on the slide rails so that the camera approaches the stage of the lighting inspection machine and the camera directly faces the display panel, thereby performing automatic optic inspection. When the automatic optic inspection device fails to inspect due to a fault, the camera can be moved along the slide rail so that the camera is moved away from the stage. Since the camera is located below the slide rail, after the camera is moved to a position far from the stage of the lighting inspection machine, a large space is in the front of the lighting inspection machine, which can facilitate the entry of the personnel for manual inspection. The idleness of the lighting inspection machine is thus avoided and the inspection efficiency is improved.

The foregoing descriptions are merely preferred embodiments of the present disclosure and are not intended to limit the present disclosure. Any modification, equivalent replacement, or improvement made within the spirit and principle of the present disclosure shall be included in the protection scope of the present disclosure.

What is claimed is :

1. An automatic optic inspection device, comprising:
a housing comprising at least a top wall and a side wall, wherein the side wall is provided with a viewing port;
a slide rail fixed on the housing near the top wall; and
a camera slidably disposed on the slide rail and located below the slide rail, wherein an optical axis of the camera passes through the viewing port.

2. The automatic optic inspection device according to claim 1, wherein an extending direction of the slide rail is parallel to the optical axis of the camera.

3. The automatic optic inspection device according to claim 1, wherein a driving device is disposed on the slide rail and the driving device is configured to drive the camera to slide along the slide rail.

4. The automatic optic inspection device according to claim 1, wherein the housing further comprises a support frame on which the sidewall is disposed.

5. The automatic optic inspection device according to claim 1, wherein the housing further comprises a movable door.

6. The automatic optic inspection device according to claim 1, further comprising an inspection and analysis device disposed inside the housing, wherein the inspection and analysis device is configured to perform inspection according to image information acquired by the camera.

7. The automatic optic inspection device according to claim 6, wherein the inspection and analysis device is located at a side of the housing away from the viewing port.

8. The automatic optic inspection device according to claim 7, wherein a side door is provided at a location on the housing corresponding to the inspection and analysis device.

9. The automatic optic inspection device according to claim 1, wherein the housing further comprises a light shielding plate surrounding the viewing port.

10. The automatic optic inspection device according to claim 1, wherein the housing further comprises a display device electrically connected to the camera.

11. The automatic optic inspection device according to claim 1, wherein the housing further comprises an operating panel.

12. The automatic optic inspection device according to claim 1, wherein the housing further comprises a plurality of rollers disposed at a bottom of the housing.

13. An inspection system for a display panel, comprising a lighting inspection machine and the automatic optic inspection device according to claim 1.

14. The inspection system according to claim 13, wherein the optical axis of the camera is perpendicular to a loading surface of a stage of the lighting inspection machine.

15. The inspection system according to claim 13, wherein an extending direction of the slide rail is parallel to the optical axis of the camera.

16. The inspection system according to claim 13, wherein a driving device is disposed on the slide rail and the driving device is configured to drive the camera to slide along the slide rail.

17. The inspection system according to claim 13, wherein the housing comprises a support frame on which the sidewall is disposed.

18. The inspection system according to claim 13, wherein the housing further comprises a movable door.

19. The inspection system according to claim 13, further comprising an inspection and analysis device disposed inside the housing, wherein the inspection and analysis device is configured to perform inspection according to image information acquired by the camera.

20. The inspection system according to claim 19, wherein the inspection and analysis device is located at a side of the housing away from the viewing port.
